(19) United States
(12) Patent Application Publication
(10) Pub. No.: US 2009/0260276 A1
(43) Pub. Date: Oct. 22, 2009

(54) Behavior-tuned bed bug trap and monitoring device

(75) Inventors: Philipp A. Kirsch, West Linn, OR (US); Darek Czokajlo, West Linn, OR (US)

Correspondence Address: RAYMOND J. WERNER, 2056 NW ALOCLEK DRIVE, SUITE 314, HILLSBORO, OR, 97124, US

(73) Assignee: APTIV Inc.

(21) Appl. No.: 11/703,320

(22) Filed: Feb. 6, 2007

Related U.S. Application Data
(60) Provisional application No. 60/765,532, filed on Feb. 6, 2006.

(51) Int. Cl. A01M 1/00; A01M 1/14; A01M 1/20; H04Q 5/22

(52) U.S. Cl. 43/114; 43/131; 43/123; 340/10.1

(57) ABSTRACT

A trap for ectoparasitic arthropods with cryptic behavior, such as bed bugs, includes one or more dimensions of attractants, as well as the physical attributes of hiding places preferred by bed bugs. The trap may have an adhesive or fabric layer disposed within it, and the adhesive or fabric layer may include a non-volatile attractant such as a fecal matter attractant. With respect to attractants, such a trap may include one or more of a slow CO₂ leaker device, one or more temperature gradient generators, one or more heated air generators, one or more cool infra-red (IR) sources, one or more volatile chemical attractants, and one or more non-volatile chemical attractants.

### CROSS-REFERENCE TO RELATED APPLICATIONS

This application claims the benefit of U.S. Provisional Application 60/765,532, filed 6 Feb. 2006, and entitled “Behavior-Tuned Bed Bug Trap And Monitoring Device”, the entirety of which is hereby incorporated by reference.

### FIELD OF THE INVENTION

The present invention relates generally to traps used for capturing, and possibly killing, pests such as, for example, ectoparasitic arthropods of medical and veterinary importance and with cryptic behavior. Such traps may also be deployed for controlling ectoparasitic arthropod infestations by removal of individuals and reduction of the population. More particularly, the present invention relates to traps suitable for determining the presence of pests, such as bed bugs.

### BACKGROUND

Pests such as bed bugs are a significant problem, and recently the problem of bed bug infestations has been increasing. The hotel industry in particular has an especially keen interest in reducing, or eliminating, bed bugs from their establishments.

Bed bugs are small nocturnal insects that feed on human blood. One result of bed bug bites is significant itching. Another result is blood-stains on bedding. A further possible consequence is the transmission of diseases such as Hepatitis A or Hepatitis B. It is desirable to prevent the spread of bed bugs to homes and other facilities.

Generally, one or more applications of chemical treatments by pest management professionals are required to eliminate bed bugs. It is noted that such pest management professionals are typically called when a hotel or property manager is made aware of the presence of bed bugs. In the hotel industry, it is often left primarily to the cleaning staff to look for evidence of the presence of bed bugs, and to report this evidence to hotel management.

Unfortunately, bed bugs may be present without the cleaning staff being able to regularly make such a determination.

What is needed are methods and apparatus for determining the presence of bed bugs, and of providing such information to property and/or pest management professionals.

### SUMMARY OF THE INVENTION

Briefly, a trap for ectoparasitic arthropods, such as bed bugs, includes one or more dimensions of attractants, as well as the physical attributes of hiding places preferred by targeted pests, such as, for example, bed bugs.

With respect to attractants, such a trap may include one or more of a slow CO₂ leaker device, one or more temperature gradient generators, one or more heated air generators, one or more cool infra-red (IR) sources, one or more sound generators, one or more vibration generators, one or more volatile chemical attractants, and one or more non-volatile chemical attractants or stimulants.

### BRIEF DESCRIPTION OF THE DRAWINGS

FIG. 1 is a cross-sectional view of a trap in accordance with the present invention.

FIG. 2 is an illustration of a heater strip suitable for producing a temperature gradient.

FIG. 3 is an illustration of an alternative heater strip suitable for producing a temperature gradient.

FIG. 4 is an illustration of another alternative heater strip suitable for producing a temperature gradient.

FIG. 5 is a flow diagram illustrating a method in accordance with the present invention.

FIG. 6 shows an alternative trap construction having two layers of plastic separated by a spacer, and further having a hole in one of the plastic layers where a lure may be placed.

FIG. 7 shows an alternative trap construction having concentric spaced apart tubes.

### DETAILED DESCRIPTION

Generally, the present invention relates to determining the presence of ectoparasitic arthropods with cryptic behavior. Traps in accordance with the present invention include various physical attributes and attractant mechanisms that are tuned to the behavior of one or more target insects or arachnids.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

### Terminology

Bed bugs, kissing bugs, and fleas are all insects. Ticks and parasitic mites are arachnids. These are all arthropods, hence the use of the term arthropods herein. However, crayfish and centipedes are also arthropods. Generally, embodiments of the present invention are more typically directed to use with insects and arachnids.

The expression “cryptic behavior” refers to a behavior in which insects or arachnids hide in the general environment of the host for long intervals, and then come out for irregular feeding when a host becomes available.

The term “semiochemical” refers to a volatile or non-volatile chemical that modifies the behavior of an organism which detects that chemical.

The terms, integrated circuit (IC), semiconductor device, monolithic device, microelectronic device, and chip are often used interchangeably in the field of electronics. The present invention is applicable to all the above as they are generally understood in the field.

The terms, single-chip microcomputer, microcontroller, embedded controller, embedded processor and similar variants are often used interchangeably when referring to integrated circuit implementations of stored program controlled computational resources, and are generally meant to include single-chip digital data processing devices such as those exemplified by the well-known 8051 family of microcontrollers, which are commonly available from a wide variety of electronics suppliers.

### Illustrative Embodiment

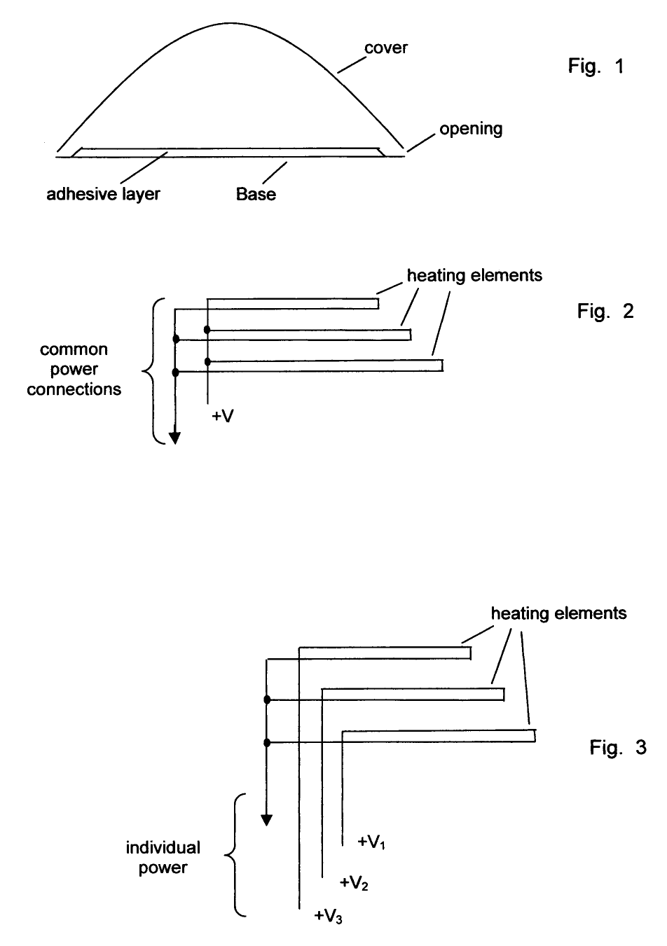

In one illustrative embodiment of the present invention, shown in FIG. 1, a trap comprises a body with one or more entry points that resemble the preferred entry points of bed bug hiding places. In this way, the trap mimics a refuge of the style commonly used by bed bugs. In some embodiments, the entry points of the trap resemble a thin crack, or slit, such as may be found, for example, between baseboard molding and a wall or floor. The trap body of the illustrative embodiment is opaque, or substantially opaque, to visible light. The exterior of the trap body may be designed to be non-reflective of wavelengths of light that may cause ectoparasitic insect or arthropod aversion to entry. Various embodiments of the present invention may further include an adhesive layer disposed within the body of the trap. The adhesive layer acts to retain bugs that have entered the trap so that such bugs may be subsequently identified and/or counted. In some embodiments the adhesive layer laid out, or arranged, so that there is an area within the trap, adjacent to the one or more entry points, where the adhesive layer is not present. In this way, a build up of bed bugs stuck to the adhesive layer at the entry points does not exist, and therefore does not interfere with the entry of additional bed bugs.

Alternative embodiments of the present invention may further include a layer of fabric or several layers of smooth or crumpled fabric disposed within the body of the trap. The fabric layer acts to present a refuge to retain bugs that have entered the trap so that such bugs may be subsequently identified and/or counted. In further embodiments these fabric layers may be treated with insecticide (or impregnated with insecticide for controlled release of the toxic agent) and laid out, or arranged, so that there is an area within the trap, in the preferred refuge sites, where the insecticide is present and causes the death of the bugs on contact. In this way, bugs can be killed within the trap and the device may be used as a control measure.

In some embodiments of the present invention, the trap includes a sealing mechanism that allows the trap to be opened for inspection only by authorized personnel. In some embodiments, the body of the trap has a relatively low profile, or height, so that it is not very noticeable to a guest in a hotel room that has such a trap disposed therein. It will be appreciated that the exterior of the trap may be color-coordinated with the room in which it is placed so as to reduce the observability of the trap by the guest.

In some embodiments, the trap may be attached to a substrate to be sampled, or monitored, in such a way that no bed bug refuge or entry point is created or remains between the trap and the substrate.

In some embodiments, the trap includes two or more parts. A first one of these two or more parts may be a housing or docking station that is permanently installed in the location to be monitored. One or more other parts, of the two or more parts, are removable, and can be replaced at, for example, the time of trap inspection. The removable parts may include a quick release mechanism to facilitate efficient servicing, however any suitable means for removable attachment may be used. It will be appreciated that one or more attractants may be disposed either in the permanent housing, or in the replacement part or parts, or in a combination of both.

### Attractants

Traps in accordance with the present invention may include one or more attractant means or mechanisms. Attractants may be used to motivate the target insect or arachnid, bed bugs in this case, to orient towards, and approach the trap. As discussed in greater detail below, attractants may be various combinations, of heat, infra-red radiation, temperature gradients, volatile chemicals, non-volatile chemicals, and sounds. Once the bugs, i.e., insects or arachnids, are proximate to the trap, they may enter the trap either because it appears to physically resemble a preferred hiding place, or because one or more attractant mechanisms causes the bugs to orient such that they are likely to enter the trap.

Since nocturnal blood-sucking insects or arachnids, such as bed bugs, must find hosts in the dark, a heat source may be used to orient the bed bugs towards the trap. In some embodiments the heat source may be disposed within the trap, while in other embodiments the heat source may be located external to the body of the trap. In some embodiments, both internal and external heat sources may be provided. FIGS. 2-4 show illustrative examples of heat sources.

With respect to heat sources, a “point” source of heat, such as a very small heating coil or similar resistive heating element, may be used. Alternatively, one or more heater strips may extend outwardly from the body of the trap. Such heater strips may each be provided with a single heating element, or with a plurality of heating elements. By providing a heater strip with a plurality of heating elements a temperature gradient may be established. For example, an illustrative heater strip, as shown in FIG. 2, has three resistive heating elements disposed therein, with each of the heating elements providing a substantially equal amount of heat output per unit length; a first heating element which runs the length of the heater strip, a second heating element which runs in parallel with the first heating element for two thirds of the length of the heater strip, and a third heating element which runs in parallel with the first and second heating elements for one third of the length of the heater strip. In such an arrangement, the section of heater strip with two parallel heating elements is warmer than the section with only one heating element. Similarly, the section of heater strip with three parallel heating elements is warmer than the section with only two heating elements. In this way, a temperature gradient may be achieved. It is noted that other physical arrangements of heating elements may be used to produce a variety of temperature gradient patterns.

Various alternative arrangements of heater elements within a heater strip are contemplated by the present invention. In particular, heater element arrangements are contemplated whereby moving hot and cold spots can be achieved, as well as both linear (substantially constant change in temperature per unit distance) and non-linear (varying change in temperature per unit distance) temperature gradients. Such complex heat patterns can be readily achieved through the use of a programmable device, such as a microcontroller, that can be programmed to provide the control signals which determine the amount of current passing through each of a plurality of resistive heating elements disposed throughout a heater strip.

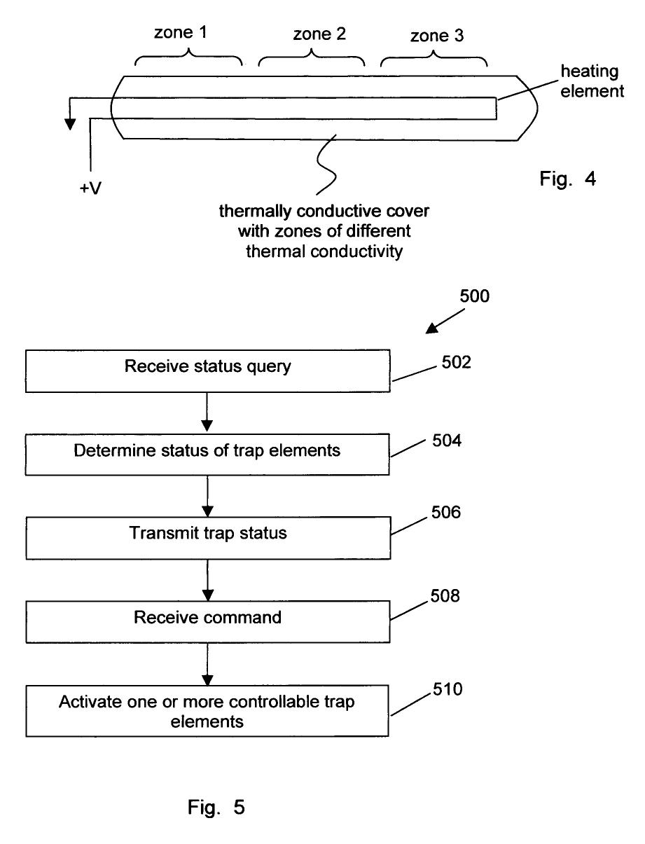

With respect to the establishment of temperature gradients, an alternative to a heater strip with several heating elements of varying length, is a heater strip that achieves a temperature gradient through the use of varying amounts of heat insulating material. In other words, as shown in FIG. 4, a single heating element disposed within a heating strip where that heating element is surrounded by a covering that has heat transfer characteristics which vary over its length. For example, a material having a predetermined heat transfer characteristic is applied over the heating element, such that the thickness of the material varies along the length of the heating element. In this way, a temperature gradient is achieved because less heat is transferred through the thicker regions of insulation.

Similarly, a temperature gradient can be achieved by facilitating, rather than retarding, heat transfer. In this alternative, heat slugs, fins, or other thermally conductive elements may be disposed near the heating element at certain positions along the length of the heating element. In this way, more heat is transferred at the locations with the heat slugs, or fins.

In various alternative embodiments, heater control mechanisms may be included. Through these heater control mechanisms, heating elements may be controlled such that the individual heat output of each heating element is different at different times in order to produce a time-varying temperature gradient pattern. Such modulation of the heat output of the heating elements may be achieved by, for example, varying the amount of electrical current that is provided to various ones of the heating elements (see FIG. 3). The particular timing and electrical current levels can be controlled by well-known digital logic circuits. For example, a microcontroller, or similar computational resource, may be programmed to control the delivery of electrical power to the heating elements in order to produce the desired temperature gradients, regardless of whether the gradients are to be static or time-varying. The aforementioned microcontroller, computational resources, and/or digital logic, may all be implemented on one or more integrated circuits. Such integrated circuits may be disposed within the body of the trap. These integrated circuits may further include communication functionality so that upon detection of the presence of bed bugs, or other pests, a predetermined entity may be notified. Such detection may be achieved in any suitable manner including, but not limited to, digital image scanning within the body of the trap, leg movement sensing, and signature scent sniffing to detect a particular bug odorant.

It will be appreciated that communication functionality such as IEEE802.11x (Wi-Fi) may be incorporated so that a trap used in a hotel with Wi-Fi access provided therein, may use the hotel's own communication infrastructure for alerting hotel management to the presence of bed bugs.

It will be further appreciated that the communication functions of the trap may be configured so that they are activated by a scanner operated in close proximity to the trap. For example, the trap may be equipped with an RFID style communications capability, such that when a scanner, or “tag reader”, transmits the appropriate signals, the trap responds to the query with the one or more pieces of information requested by the scanner. In the case of hotels, cleaning staff may be provided with tag readers that interrogate, or otherwise interact with, such traps, and the trap may report the presence or absence to the tag reader, or make other similar communications.

Alternatively, one or more infra-red (IR) sources may be provided in various embodiments of the present invention as an attractant for nocturnal blood-sucking insects or arachnids. Such IR sources may be relatively cool in that they simply radiate photons in the infra-red range without conventional heating elements. Light emitting diodes or laser diodes which emit photons in the infra-red range may be used. Such Infra-red radiation may be generated continuously, or may be modulated. It will be appreciated that such modulation may be with respect to output wavelength, output intensity (i.e., brightness) and/or duty cycle. It will be appreciated that when an IR source is combined with one or more other attractant mechanisms, that proper consideration should be given to the interactions therebetween and how such interactions may impact the efficacy of the various attractant mechanisms. For example, when an IR source is used in conjunction with a CO₂ gas source, the absorption of IR radiation by the CO₂ gas must be taken into account.

It will be appreciated that a single embodiment of the present invention may include both IR sources and resistive heating elements.

Various embodiments of the present invention may include arrangements for providing currents of warm air such as may be generated by a sleeping warm-blooded host. In these embodiments various chimney style arrangements may be used in which cool air is brought into the proximity of one or more heating elements to be warmed, and a pathway is provided for the warm air to escape. In some embodiments, the warm air is enriched with CO₂ from a CO₂ source or generator that is part of the trap system. In alternative embodiments, the CO₂ may be heated and dispersed without having first been mixed with air.

Chemical attractants may be used in addition to, or as an alternative to, appealing to infra-red and/or thermo-receptors of the bugs. For example, volatile semiochemicals in a lure may be disposed with various embodiments of traps in accordance with the present invention. It is well understood by those skilled in the art that controlled release formulations, also called lures, can be designed to deliver or meter semiochemicals into the environment at precise rates that can be optimized for the maximum attraction and capture of the target pest. Volatile semiochemical attractants for bed bugs may be derived from either host, conspecific bugs or environmental origins. Host or conspecific odors (volatile semiochemicals) may include, Acetaldehyde, Acetic acid, Acetone, Ammonia, Ammonia+1-Octen-3-ol, Amyl alcohol, Benzaldehyde, Butanoic acid, Butylamine, 2-Butyric acid, Carbon dioxide, Carboxylic acids (including compounds such as (E)- and (Z)-3-methyl-2-hexenoic acid, 7-octenoic acid, 9-octadecenoic acid, 9-hexadecenoic acid, 2-oxopentanoic acid, and 9,12-octadecadienoic acid), p-Cresol, Dichloromethane, Dimethyl amine, Dimethyl disulfide, 1-Dodecanol, Ethanol, Geranyl acetone, Heptanal, Hexanal, Hexenal, Hexanoic acid, 3-hydroxy-2-butanone, Indole, Isoamyl alcohol, Isobutyl alcohol, Isobutyl amine, Isobutyric acid, Isohexanoic acid, Isovaleric acid, L-lactic acid, methyl-2-hexanone, 3-methyl-1-butanol, 6-methyl-5-hepten-2-one, 3-Nonanal, Nonanoic acid, Octanal, Octanoic acids, 1-Octen-3-ol, Pentanoic acid, 1-phenylethanol, 2-Propionic acid, Pyruvate, Lactate, Amyl acetate, a synthetic mixture of Quinazolines, Triethyl amine, and Valeric acid.

It is noted that carbon dioxide can be delivered (leaked) from a small cylinder such as those used for bicycle tire inflation. In some embodiments, the CO₂ is heated so that it appears to more closely match the temperature of the CO₂ exhaled, or otherwise exuded, by a host. In some embodiments, carbon dioxide may be generated via the sublimation of dry ice, or through the reaction of one or more chemicals that are activated upon deployment of the trap, or at a different time as directed via input from an integrated digital circuit, which provides various control signals to the device. It will be appreciated that a chemical reaction may also be designed to generate heat, as well as CO₂, which is attractive to the target pests. It is also noted that water, or water vapor may be an attractant or a component of an attractant blend, and that it may act to synergize the attractivity of other semiochemicals. It is noted that the combinations, or blends, of two or more volatile semiochemicals may be more efficacious than either constituent semiochemical alone.

Alternatively, non-volatile semiochemicals may be incorporated in the adhesive layer within the trap, or in other embodiments within the fabric layer or layers in the trap; for example, aggregation attractants in fecal material (e.g., guanine). Other contact semiochemicals (arrestants, phagostimulants) include but are not limited to A(tetra)P, ATP, deoxyATP, CTP, ADP, GTP, CDP, ITP, cAMP, UTP, deoxyADP, IDP, GDP, AMP, Saline solution, Purines and other nitrogenous compounds (including guanine, purine, adenine, allantoin, hypoxanthine, xanthine, uric acid, ammonium chloride, ammonium nitrate, and ammonium sulfate, 8-Azaguanine and aminopurine), and Hematin. It is noted that combinations, or blends, of two or more of the foregoing compounds may be more efficacious as an attractant than the constituent compounds alone.

It is also noted that combinations, or blends, of volatile and non-volatile semiochemical attractant compounds may be more efficacious as an attractant than the constituent compounds alone.

Still further attractants may be had in the form of one or more sound components. That is, by mimicking at least a portion of the audio spectrum, or substrate-borne vibrations, produced by a sleeping host, it may be possible to attract the target insects to the trap. Alternatively, sounds other than those of a potential host may also be attractive to the target insect, and the generation of such sounds is contemplated by the present invention. Sounds may be generated by means of a small speaker controlled by the aforementioned microcontroller. It will be understood that any appropriate control and amplification circuits may be used to drive the speaker. Alternatively, the speaker may be replaced by any suitable form of audio generation device, including but not limited to a vibratory mechanism that induces vibrations in a wall or floor that may be sensed by the target insect.

Various embodiments of the present invention may be configured with a variety of attractants and the ability to receive commands. Such suitably configured embodiments, may receive a command to activate and/or dispense one or more attractants based at least in part on receiving a command to attract a particular set of pest species.

In some embodiments, heat and sound are combined to attract the target pests. In other embodiments, heat, sound, and odor, are combined. It will be appreciated that any suitable combination of heat, temperature gradient, odors, and sound, along with the physical shape of the trap entry points, may be used to tune the trap for one or more particular ectoparasitic arthropods with cryptic behavior.

### Electrical Power

With respect to a source of electrical power, such a source may be disposed within the body of the trap, or disposed external to the body of the trap. Alternatively, a combination of internal and external power hardware may be provided. The power source may be one or more batteries. Alternatively, a power source may coupled to the power consuming elements of the trap via wired connection. The power source coupled by wired connection may be either an AC or a DC source. In an alterative arrangement, electrical power may be provided by an external RF energization field. It will be appreciated that the various elements of a trap in accordance with the present invention that consume electrical power may be connected to different power sources. It will be further appreciated that the various power consuming elements may be selectively coupled to one or more sources of electrical power.

### Active Control of Trap Operations

As noted above, various embodiments of the present invention may include one or more actively controllable features, or elements. Such actively controllable features or elements, include, but are not limited to, turning an IR source on and off, modulating an IR source (e.g., duty cycle, frequency, brightness, and/or output wavelength), turning a heater element on and off, controlling the temperature setting of the heater element, turning a temperature gradient generator on and off, controlling the temperature gradient (i.e., the change in heat output per unit distance (which change may be linear, non-linear, or a combination of linear and non-linear), receiving commands and programming information from a remote source of commands and programming information, transmitting status information (e.g., battery condition, quantity of attractant(s) remaining, presence of pests in trap), turning a sound generator on and off, modulating the output of the sound generator, turning a vibration generator on and off, modulating the output of the vibration generator, and determining when to release one or more attractants.

It will be appreciated that the operation of such actively controllable features or elements may be controlled by, for example, a microcontroller that has been programmed to operate the various aspects of the trap, including but not limited to, attractant mechanisms, communications, and power management. More generally, the circuitry responsible controlling the functionality of the trap may be referred to as a controller, or as a control circuit. This terminology is not intended to place any limitations on the physical implementation of mechanisms to control the functionality of the trap.

The architectural and operational characteristics of microcontrollers are extremely well known, and therefore these devices are not described in greater detail herein. Those skilled in the art and having the benefit of this disclosure will appreciate a wide variety of a electrical circuit topologies in which the various Input/Output (I/O) terminals of a microcontroller may be used to directly or indirectly control the flow of current to various elements of the trap, as well to open and close various electrical switches. It will be further appreciated by those skilled in the art and having the benefit of this disclosure that any suitable form of computational resource may be used and that the present invention is not limited to the use of microcontrollers. For example, control circuitry consisting of hard-wired logic circuits, rather than a programmable microcontroller may be used to achieve such control functions.

In various embodiments of the present invention, the activation or dispensing of various attractants may be initiated or suspended by the controller of the trap, based upon one or more of a number of factors. For example, such activation and/or dispensing may begin upon the trap wirelessly receiving a command to begin the use of attractants. FIG. 5 illustrates a method 500 of wirelessly interacting with a trap in accordance with the present invention. More particularly, the trap receives 502 a status query. In this example the query is received wirelessly, but it is noted that alternative embodiments may receive such a query by way of a wired connection. The trap, typically by way of a microcontroller or equivalent circuitry and/or program code, determines 504 the status of the trap, and responsive to the received query, transmits 506 the requested status information either to the inquiring entity or to a destination that may be otherwise specified by the system operator. In this illustrative method, after receiving and responding to a status query, the trap receives 508 a command, and responsive thereto activates 510 one or more controllable trap elements. For example, the trap may receive a command to activate a CO₂ source to begin attracting pests.

In a further example, the trap controller is provided with a real-time clock and based on a predetermined schedule initiates and/or suspends the activation and/or dispensing of attractants. In some instances the controller may adjust the schedule of activation and/or dispensing based, at least in part, on the amount of battery charge remaining. In some embodiments, the controller may select a subset of the attractants available for activation and/or dispensing so as to reduce charge consumption thereby increasing battery life.

It will be appreciated that various elements of the trap (attractant or otherwise) may be turned on or off by a microcontroller to both optimize arthropod capture, or to conserve power and maximize battery life and trap longevity. As indicated above, not all components of the trap must be powered concurrently. In some embodiments, the trap may be activated based on prior knowledge of the target arthropod behavior and activity pattern. In other embodiments, the trap may be activated based on human activity patterns (e.g., hotel room occupancy). For example, vibration or sound of movement in a room may activate the trap, or may turn off the trap depending on management goals. In some embodiments, sensors external, yet communicatively coupled to, the trap, may provide input to the computational resources of the trap in making these decisions. In some embodiments, a photosensor is used to determine when the room in which the trap is disposed becomes dark (i.e., the ambient light intensity falls below a predetermined threshold); and when the determination is made that the room is dark, the computational resources of the trap activate one or more of the active components of the trap.

In accordance with the present invention, a pest-specific ectoparasitic arthropod trap may be disposed within a room, or a plurality of traps may be deployed to form a trap network, or array, within two or more rooms throughout a property, as the foundation of a pest surveillance service, a pest-free certification program, or as a counter to fraudulent customer claims. In other words, deploying traps, in accordance with the present invention, allows a property manager, to know whether one or more particular pests are present within a property, what pests in particular, if any, are present, and the specific areas of infestation. Such a deployment provides new opportunities in terms of revenue generation and/or cost and liability reduction with respect to bed bug management in the hospitality sector.

In a further aspect of the present invention, various pest management advice and pest management service businesses receive information, directly or indirectly, which information originates from a network of behavior-tuned traps such as are described above. One such service is an independent certification of bed bug free property, wherein an organization, independent of the management of the property being monitored, determines, based at least in part, on the contents of the behavior-tuned traps, that such a certification is warranted by absence of detection of bed bugs. Such services can be offered to, for example, hotels, residential property managers, universities and colleges that manage dormitories, and to warehouse and self-storage facility managers. By reducing fraudulent claims through the use of the present invention, preferred or favorable insurance rates may be achieved by customers of these services.

In a further alternative embodiment, an independent certification service could be directed to provide reports to the insurance provider. Similarly, the independent certification service may provide a secure link to the raw data received from the traps. In a further alternative arrangement, the wireless communication capability of traps so equipped, can be adapted to receive and authenticate a query from an insurance carrier or other third party auditor, so that real-time verification of infestation status can be obtained.

In one embodiment of the present invention, the trap includes a body that is characterized by opaqueness to visible light, and further characterized by the presence of at least one entry point shaped so as to resemble a thin crack in a wall.

In an alternative embodiment, a trap further includes one or more of various attractants selected from the group consisting of heating elements, infra-red light sources, volatile semiochemicals, contact semiochemicals, and sound generators.

In a still further alternative embodiment, the trap has an adhesive layer disposed within it, upon which an insect becomes trapped. In some embodiments, the adhesive layer contains contact semiochemicals such as aggregation attractants in fecal material (e.g., guanine). In some embodiments the adhesive layer contains an insecticide.

In yet another alternative embodiment, the trap has a fabric layer or layers disposed within it, within which the insect seeks refuge. In some embodiments, the fabric layer (either toxic or non-toxic) contains contact semiochemicals such as aggregation attractants in fecal material (e.g., guanine).

It will be appreciated that various embodiments of the present invention may include materials for what is referred to as “attract-and-kill” (A & K). In other words, combinations of one or more attractants with one or more insecticides.

In a still further embodiment, the trap is operable to determine the presence of a trapped bug and wirelessly communicates this information to a predetermined receiving entity.

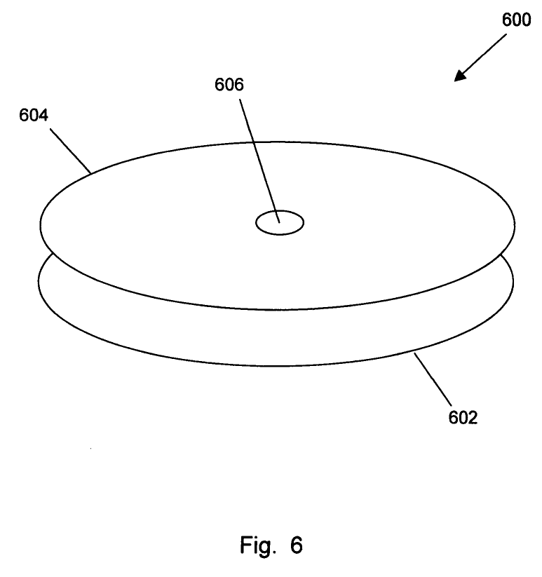

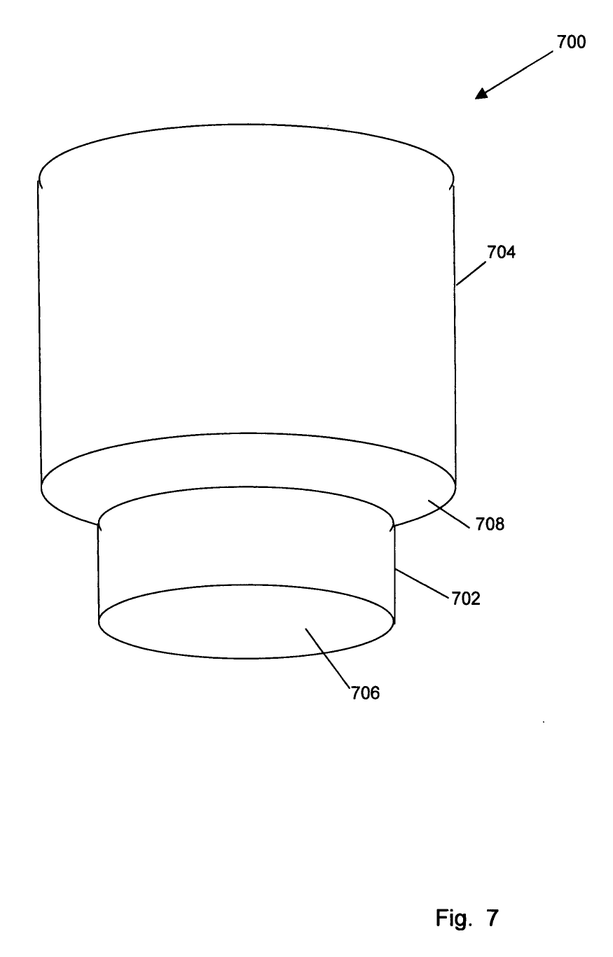

FIGS. 6 and 7 illustrate alternative physical constructions of traps in accordance with the present invention. FIG. 6 shows a trap 600 having two circular layers of plastic 602, 604 separated by a spacer. As shown, plastic layer 604 has an opening in its exposed upper surface in which a lure may be placed. FIG. 7 shows a trap 700 which may act as a false bed leg. Trap 700 includes an inner tube 702 and an outer tube 704 that is disposed such that inner tube 702 fits within outer tube 704. The inner diameter of inner tube 702 is chosen so that it is large enough to slide onto a bed leg. The space 708 between inner tube 702 and outer tube 704 is selected to mimic the type of opening preferred by a targeted pest. It will be appreciated that the outer surface of inner tube 702, the inner surface of outer tube 704, or both may be made to have non-cylindrical surfaces so as to more closely mimic the preferred entry point of a targeted pest.

### Conclusion

Embodiments of the present invention provide methods and apparatus for attracting, trapping, and in some embodiments killing, various pests, such as but not limited to bedbugs, kissing bugs, parasitic mites, ticks, and fleas.

An advantage of some embodiments of the present invention is that an early and reliable determination regarding the presence of bed bugs can be made.

An advantage of some embodiments of the present invention is that hotel cleaning staff may be relieved of the responsibility for finding evidence of the presence of bed bugs.

An advantage of some embodiments of the present invention is that trap networks or arrays may be deployed throughout a property for continuous real-time target pest detection as a foundation for a pest surveillance service, or a pest-free certification service.

It is to be understood that the present invention is not limited to the embodiments described above, but encompasses any and all embodiments within the scope of the subjoined Claims and their equivalents.

What is claimed is:

1. A trap, comprising:
a body having at least one entry point, the trap body substantially opaque to visible light; and
a material layer disposed within the body, the material layer selected from the group consisting of an adhesive layer and a fabric layer;
wherein the shape of the at least one entry point mimics a refuge preferred by at least one ectoparasitic arthropod with cryptic behavior.

2. The trap of claim 1, wherein the exterior of trap body is non-reflective of wavelengths of light that cause the at least one ectoparasitic arthropod aversion to entry.

3. The trap of claim 1, wherein the material layer is laid out so that there is an area within the trap adjacent to the at least one entry point where the material layer is not present.

4. The trap of claim 1, wherein the shape of the at least one entry point is a slit.

5. The trap of claim 1, further comprising one or more attractants disposed within the trap.

7. The trap of claim 5, wherein at least one of the one or more attractants comprises a CO₂ source.

8. The trap of claim 1, further comprising a heat source.

9. The trap of claim 8, wherein the heat source comprises is disposed external to the trap.

10. The trap of claim 1, further comprising a computational resource disposed within the body, and a photosensor coupled to the computational resource for determining the light level external to the trap.

11. A trap, comprising:
a body having at least one entry point, the body substantially opaque to visible light;
a material layer disposed within the body, the material layer selected from the group consisting of an adhesive layer and a fabric layer;
at least one chemical attractant source disposed within the body;
at least one non-chemical attractant source disposed within the body;
control circuitry coupled the at least one chemical attractant source and to the at least one non-chemical attractant source; and
wherein the shape of the at least one entry point mimics a refuge preferred by at least one ectoparasitic arthropod with cryptic behavior; and wherein the control circuitry is operable to activate release of at least one chemical attractant from the chemical attractant source.

12. The trap of claim 11, wherein the at least one ectoparasitic arthropod with cryptic behavior is a bed bug.

13. The trap of claim 11, further comprising communication circuitry coupled to the control circuitry, wherein the communication circuitry is operable to wirelessly receive and transmit information.

14. The trap of claim 13, wherein the release of at least one chemical attractant is responsive to a command received by the communication circuitry.

15. The trap of claim 13, wherein the communication circuitry is responsive to an RFID tag reader.

16. The trap of claim 11, wherein the at least one non-chemical attractant source is a heat source, and the heat source is operable to produce a predetermined temperature gradient.

17. The trap of claim 11, wherein the at least one non-chemical attractant source is an infra-red source.

18. The trap of claim 11, further comprising at least one insecticide source disposed within the body.

19. A method of operating a trap having at least one entry point shaped to mimic a refuge preferred by at least one ectoparasitic arthropod, comprising:
receiving a status query;
determining the status of the trap;
transmitting, responsive to the status query; the determined status of the trap;
receiving a command; and
activating one or more controllable trap elements.

20. The method of claim 19, wherein the status includes the status of one or more functional elements of the trap.
